(19) United States
(12) Patent Application Publication
(10) Pub. No.: US 2026/0017613 A1
(43) Pub. Date: Jan. 15, 2026

(54) ADAPTIVELY SYNCHRONIZING AND LINKING DIGITAL MEDIA UTILIZING LARGE LANGUAGE MODELS

(71) Applicant: Dropbox, Inc., San Francisco, CA (US)

(72) Inventor: Takayuki Okazaki, Meguro City (JP)

(21) Appl. No.: 18/769,192

(22) Filed: Jul. 10, 2024

(51) Int. Cl. G06Q 10/10; G06F 16/27

(52) U.S. Cl. CPC G06Q 10/103

(57) ABSTRACT

The present disclosure relates to systems, non-transitory computer-readable media, and methods for generating information flow patterns utilizing a large language model and content item embeddings, and utilizing information flow patterns to determine notifications and modifications. To illustrate, the disclosed methods can extract content item embeddings from content items and provide content item embeddings to a large language model in order to generate information flow patterns that include communication between teams. Accordingly, the disclosed methods can utilize document embeddings from new modifications to generate information flow patterns for a corresponding project. Thus, the disclosed methods can utilize the information flow pattern to determine corresponding notifications or modifications to projects or content indicated by the information flow pattern.

### BACKGROUND

Advancements in computing devices and networking technology have given rise to a variety of innovations in cloud-based digital content storage and access. For example, online digital content systems can provide access to, and synchronize changes for, digital content items across devices all over the world. Indeed, modern online digital content systems can provide access to, and communicate about, digital content for user accounts across diverse physical locations and over a variety of computing devices. Despite these advances, however, existing digital content systems continue to suffer from a number of disadvantages, particularly in terms of flexibility and efficiency.

As just suggested, some existing digital content systems are inflexible. In particular, the synchronization and content association process of many existing systems is rigidly fixed to the conventional paradigm of devices transferring updated content through stratified layers of an organizational hierarchy only in response to specific device interactions initiating the transfers. To propagate a change to a content item, existing systems generally require either updating a commonly shared cloud version of the content item or updating independently saved versions of the content item across user accounts receiving the change. In cases where a content item update is propagated across user accounts that do not share a commonly stored cloud version of the content item (such as for user accounts in different layers of an organizational hierarchy), such propagation is generally performed only in response to express input transferring an updated version of the content item to recipient accounts and replacing the previous version with the updated version at storage locations for each recipient account. This type of update, transfer, and replace process rigidly requires many layers of device interaction, and the device interactions only increase with the number of teams or accounts involved downstream, as one team or account passes the updated version to another team or account down the line through the organization. Indeed, in most existing systems, content item synchronization across multiple layers of teams or accounts is solely possible through a daisy chain of user accounts transferring an updated version from a source account that created the updated version to a final account downstream, often separated by multiple layers or in between.

Additionally, many existing digital content systems maintain, transfer, and store inaccurate versions of content items. Indeed, because a user account that updates a content item can be many hierarchical layers removed from an ultimate destination account that receives the updated content item, existing digital content systems often pass and store obsolete or inaccurate versions of the content item. To illustrate, many existing digital content systems fail to reflect the most recent iterations or updates to a content item as the content item is passed layer by layer through the daisy chain over time, where, by the time a user account in the final layer receives the content item, additional updates have already been made by the originating account (resulting on multiple conflicting versions of the same content item). This problem is compounded when these updates are being made by unconnected user accounts on unconnected content items, especially when many layers apart in a daisy chain of user accounts. Such inaccuracies can lead to incompatible versions of related content items (e.g., application versions), resulting in computing errors in cases where processes intended for the most recent updates are implemented on content items which include incorrect or incompatible (e.g., outdated and/or missing) content.

Due at least in part to their inflexibility, many existing digital content systems are also inefficient. Aside from consuming excessive computer storage by storing multiple versions of the same content item, many of which are inaccurate and obsolete, existing systems often require frequent navigation between multiple different content items and content item versions, including across different user accounts. Beyond content item modification, existing systems further lack any ability of these various user accounts to detect the differences across different versions, which can lead to incompatibilities across versions. Not only is such frequent context switching navigationally inefficient (requiring excessive and/or repetitive client device interactions to propagate necessary updates), but it is computationally inefficient as well. Indeed, changes to content items that are done independently can lead to incompatibilities that cause errors and, consequently, wasted computing resources, especially as devices reprocess data for the same content item multiple times (e.g., resulting from errors detected from incompatible versions). Additionally, initiating and running various content item versions and/or applications for processing the different versions consumes excess computing resources, especially when running the applications simultaneously. To illustrate, switching back and forth between content item or application versions consumes excessive amounts of memory as a client device caches larger amounts of data for each of the versions that is frequently accessed (as compared to idle or less frequented applications). Accordingly, because existing digital content systems require manual modification of various documents, such navigation between documents wastes time and computer memory.

Thus, there are several disadvantages with regard to existing digital content systems.

### BRIEF SUMMARY

Embodiments of the present disclosure provide benefits and/or solve one or more of the foregoing or other problems in the art with systems, non-transitory computer-readable media, and methods for generating content item embeddings and utilizing content item embeddings in combination with a large language model to determine an information flow pattern between teams within an organization. More specifically, in one or more embodiments, the disclosed systems identify content item embeddings from digital content items that include indications of content item modifications and corresponding timestamps. Further, in some embodiments, the disclosed systems process the content item embeddings from the content items utilizing a large language model to determine a variety of information flow patterns between teams. Accordingly, in one or more embodiments, the disclosed systems can utilize a content item modification to predict and execute an information flow pattern between teams for the modified content item.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a content item embedding information system can operate in accordance with one or more embodiments.

FIG. 2 illustrates an overview for the process of utilizing a large language model to determine an information flow pattern in accordance with one or more embodiments.

FIG. 3 illustrates a vector space for content item embeddings in accordance with one or more embodiments.

FIG. 4 illustrates a process for determining an information flow pattern based on proximity in a vector space for content item embeddings in accordance with one or more embodiments.

FIG. 5 illustrates a process for automatically updating projects and generating notifications in accordance with a determined information flow pattern in accordance with one or more embodiments.

FIG. 6 illustrates an example update communication in accordance with one or more embodiments.

FIG. 7 illustrates an example flowchart of a series of acts for determining an information flow pattern utilizing a large language model in accordance with one or more embodiments.

FIG. 8 illustrates a block diagram of an exemplary computing device in accordance with one or more embodiments.

FIG. 9 illustrates an example environment of a networking system having the content item embedding information system in accordance with one or more embodiments.

### DETAILED DESCRIPTION

This disclosure describes one or more embodiments of a content item embedding information system that can extract content item embeddings in response to detecting a modification and use a large language model to process the content item embeddings to determine information flow patterns for projects. More specifically, the content item embedding information system can extract content item embeddings from content items that include content item modifications and corresponding timestamps. Further, in one or more embodiments, the content item embedding information system processes these content item embeddings from a database of content items using a large language model to generate information flow patterns. Accordingly, in some embodiments, the content item embedding information system can utilize these information flow patterns to generate an information flow pattern for a new content item and/or a new modification. Thus, the content item embedding information system can identify teams within an organization account likely to require information from a current project content item.

As mentioned, in one or more embodiments, the content item embedding information system extracts content item embeddings from digital content items. For example, the content item embedding information system extracts a content item embedding in the form of a latent vector representation of the embedded content data, modification data, and timestamp data corresponding to a modification made to the content data. The content item embedding information system can thus extract various content item embeddings from content items across a project.

Further, in some embodiments, the content item embedding information system processes content item embeddings using a large language model. In one or more embodiments, the content item embedding information system inputs content item embeddings from a database of digital content items corresponding to various projects. In some embodiments, the large language model utilizes the content item embeddings to generate various information flow patterns that indicate update propagations across teams and/or user accounts. Indeed, the content item embedding information system can utilize a large language model to learn an information flow pattern for a content item having a particular type, a particular originating user account (or hierarchical layer), and/or a particular destination user account (or hierarchical layer) as encoded in its content item embedding. Additionally, in one or more embodiments, the content item embedding information system processes these content item embeddings in order to generate or predict an information flow pattern corresponding to a new content item embedding—e.g., a content item embedding within a threshold similarity (e.g., cosine distance) of the content item embedding with the known information flow pattern.

In one or more embodiments, the content item embedding information system identifies a modification of a content item. As mentioned above, the content item embedding information system can extract a content item embedding in response to detecting a new modification to a content item, where the embedding includes an embedding data defining the modification and a corresponding timestamp. Further, the content item embedding information system can utilize existing information flow patterns to generate an information flow pattern characteristic of the modification corresponding to the content item embedding. The content item embedding information system can thus propagate an update of a content item to one or more downstream user accounts in response to detecting the modification by following the information flow pattern.

More specifically, in one or more embodiments, the content item embedding information system maps the content item embedding to compare the content item embedding to various information flow patterns. To illustrate, in some embodiments, the content item embedding information system utilizes an embedding space to compare the content item embedding to information flow patterns. In one or more embodiments, the content item embedding information system maps content item embeddings into an embedding space and identifies similar projects based on distances within the embedding space. Accordingly, in some embodiments, the content item embedding information system identifies the most likely information flow pattern mapped in the embedding space for a newly modified content item.

Further, in one or more embodiments, the content item embedding information system utilizes a determined information flow pattern to identify teams within an organization account that are relevant to a project. As mentioned above, an information flow pattern includes a timeline for communication and/or information sharing between teams. Accordingly, upon generating an information flow pattern for a project, the content item embedding information system can identify teams likely to have information relevant to the project and/or likely to need information from project content items. Additionally, in one or more embodiments, the content item embedding information system can utilize an organization directory to identify contact information corresponding to the relevant teams.

Accordingly, in one or more embodiments, the content item embedding information system provides information corresponding to a content item modification to relevant user accounts corresponding to teams identified in an information flow pattern. In some embodiments, the content item embedding information system generates an update propagation communication to provide to the relevant user accounts. In addition, or in the alternative, in one or more embodiments, the content item embedding information system generates and provides access to a project report document. Further, in one or more embodiments, the content item embedding information system can link and synchronize relevant portions of different content items across teams within an organization account.

As mentioned, in one or more embodiments, the content item embedding information system generates an update propagation communication by extracting data relevant to the modification from the modified content item. In one or more embodiments, the content item embedding information system utilizes the information flow pattern to identify what information from the modification is relevant to various teams. Accordingly, in some embodiments, the content item embedding information system can generate an update propagation communication in an appropriate format by inserting the determined relevant information into a communication template.

Similarly, in some embodiments, the content item embedding information system aggregates information corresponding to a project in a project report document. As mentioned, the content item embedding information system can identify information relevant to digital content item modifications and relevant to various teams. Accordingly, the content item embedding information system can add updated information to a project report document to provide real-time information regarding a project in a single graphical user interface. To this end, in one or more embodiments, the content item embedding information system utilizes determined contact information for teams in an information flow pattern to provide access to a project report document.

Further, in one or more embodiments, the content item embedding information system utilizes an information flow pattern to identify a related content item corresponding to another team. That is, in one or more embodiments, the content item embedding information system can identify content items managed by the other teams from the information flow pattern that include information relevant to the project. For example, one team may be working on a project that relies on information currently being changed by another team. In such a situation, the content item embedding information system can identify content items and/or portions of content items including information reflected in another project.

Further, in some embodiments, the content item embedding information system can automatically (e.g., without requiring express user input to initiate) synchronize and update the identified content items and/or portions of content items including information reflected in another project (e.g., leaving unmodified portions untouched or not updated). To illustrate, upon detecting a modification in a content item, the content item embedding information system can automatically modify the identified content items and/or portions of content items. Further, in some embodiments, the content item embedding information system can include such automatic modifications in an update propagation communication and/or a project report.

As suggested above, through one or more of the embodiments mentioned above (and described in further detail below), the content item embedding information system can provide several improvements or advantages over existing digital content systems. For example, the content item embedding information system can improve flexibility compared to prior systems. While many prior systems use content item management rigidly fixed to one device transferring updated content to another device only in response to specific device interactions initiating the transfer, the content item embedding information system can intelligently and flexibly propagate changes to relevant content items (e.g., without requiring user interaction to initiate). More specifically, in one or more embodiments, the content item embedding information system utilizes a large language model to generate information flow patterns for digital content items that include a projected flow of information over time through accounts, teams, or layers of an organizational hierarchy of user accounts. Thus, the content item embedding information system can flexibly identify teams and content items relevant to a variety of project and content item types. Accordingly, the content item embedding information system more flexibly propagates changes and synchronizes relevant portions of content items and projects across an organization, including across disparate teams separated by many layers in an organizational hierarchy.

Further, the content item embedding information system provides improved accuracy over conventional digital content systems. By generating and utilizing an information flow pattern for a content item, the content item embedding information system can accurately identify other user accounts and corresponding content items requiring synchronization. Accordingly, in one or more embodiments, the content item embedding information system accurately synchronizes content items and/or portions of content items. Thus, the content item embedding information system reduces or eliminates content item incompatibilities and resultant errors by maintaining accurate, up-to-date content items reflecting the most recent updates even across multiple layers in an organizational hierarchy.

Due at least in part to its improved flexibility and accuracy, the content item embedding information system can also improve efficiency over existing digital content systems. For example, as opposed to prior systems that wastefully consume computer storage by storing and maintaining multiple inaccurate and/or obsolete versions of a content item across the various hierarchical layers of accounts that use the content item, the content item embedding information system uses prevents such waste by maintaining accurate, up-to-date versions of content items. Indeed, the content item embedding information system learns and implements information flow patterns via a large language model to update content items across accounts, teams, thus preventing wasted storage on obsolete, inaccurate content items.

As an additional efficiency improvement, the content item embedding information system improves navigational efficiency over prior systems. While some prior systems are navigationally inefficient by requiring frequent navigation between different content items related to a project, the content item embedding information system utilizes information flow patterns to automatically identify and link relevant content items and portions of content items. To illustrate, by automatically updating and synchronizing related portions of content items, the content item embedding information system reduces or eliminates excess navigation between these related content items to manually update. Further, by generating a communication corresponding to changes, the content item embedding information system reduces or eliminates excess navigation between messaging or email applications and the synchronized content items.

In addition to improved storage efficiency and improved navigational efficiency, the content item embedding information system can also provide improved computational efficiency. Rather than simultaneously running various content items and applications to manually locate and propagate changes, the seamless synchronization of the content item embedding information system reduces excess user interactions required by conventional digital content systems to manually link or synchronize different content items, or even to manually update various related media. By circumventing the need of prior systems to constantly switch between a various content items, versions, or applications, the content item embedding information system thus preserves processing power and memory.

As illustrated by the foregoing discussion, the present disclosure utilizes a variety of terms to describe features and advantages of the content item embedding information system. Additional detail is now provided regarding the meaning of such terms. For example, as used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As used herein, the term “content item embedding” refers to a data package including data relevant to a content item. More specifically, in one or more embodiments, a content item embedding can include or refer to a latent vector representation of a content item in an embedding space, where the embedding encodes data defining document modifications and corresponding timestamps. For example, a content item embedding can include the content of the modification, user account information corresponding to the modification, data from the modified content item, timestamps, location data, and other metadata. In one or more embodiments, a content item embedding may correspond to a variety of content types, such as a digital document, an application, an image, or other content item types described herein. In such contexts, a content item embedding may be referred to as a “document embedding,” an “application embedding,” etc., depending on the type of content item embedded. In some embodiments, a content item embedding (e.g., a document embedding) includes or refers to a text-based description or encoding of modifications, historical transmissions of those modifications including sender and recipient accounts (in the form of updated content items), and/or timestamps of the modifications and/or transmissions.

Additionally, as used herein, the term “large language model” refers to a set of one or more machine learning models trained to perform computer tasks to generate or identify computing code and/or data in response to trigger events (e.g., user interactions, such as text queries and button selections). In particular, a large language model can be a neural network (e.g., a deep neural network) with many parameters trained on large quantities of data (e.g., unlabeled text) using a particular learning technique (e.g., self-supervised learning). For example, a large language model can include parameters trained to generate or identify modifications for digital content items and corresponding metadata, including timestamps. In addition, or in the alternative, a large language model can include parameters trained to generate information flow patterns, identify other content item embeddings or content items similar to a target content item embedding or content item.

Relatedly, as used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the content item embedding information system utilizes a large language machine learning model in the form of a neural network.

Along these lines, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, a diffusion neural network, a generative adversarial neural network, or a large language model.

As mentioned above, in one or more embodiments, the content item embedding information system can utilize a large language model to generate an information flow pattern. As used herein, the term “information flow pattern” refers to a projected or historical configuration of communication, modification, or connection of content items. To illustrate, in one or more embodiments, an information flow pattern can include data defining information or digital content passed between user accounts and/or teams within an organization account. An information flow pattern can include communication data, including contact information, subject line, communication contents, timestamps, originating accounts, and destination accounts, along with content item data indicating the identity of a transmitted content item, its content item type, and/or a summarization of the content item (as generated by a large language model). In one or more embodiments, the information flow pattern can include indications of content item embeddings and/or modifications of content items corresponding to projects relevant to the information flow pattern.

Relatedly, as used herein, the term “team” refers to a group of user accounts within an organization account (e.g., an organization account organized in a stratified or hierarchical arrangement of user accounts). In one or more embodiments, a team can include user accounts corresponding to a particular type of content item, one or more projects, or another joint intention and/or goal. In some embodiments, a team is a set of user accounts corresponding to one or more project types and/or application versions. As noted above, the content item embedding information system can identify and/or generate communication between teams.

As mentioned above, in one or more embodiments, the content item embedding information system maps content item embeddings (e.g., document embeddings) in an embedding space. As used herein, the term “embedding space” refers to a vector space including one or more document embeddings. In one or more embodiments, the embedding space is a multi-dimensional space that reflects a variety of attributes of document embeddings. Accordingly, in some embodiments, the content item embedding information system determines distances within the embedding space to approximate similarity between content item embeddings.

Further, as used herein, the term “communication format” refers to a type, layout, or organization of a message. In one or more embodiments, a communication format includes a communication method and a communication template. For example, a communication format can include a bullet-point list in an email, an instant message with pre-determined headings, a cloud document with information organized by team, or a variety of other message types and organizations.

Relatedly, as used herein, the term “project report document” refers to a digital content item including information including information for a particular project. In one or more embodiments, the content item embedding information system provides digital access (e.g., via cloud computing) or sends a project report document to various teams included in the information flow pattern corresponding to that project. In some embodiments, the project report document includes information on document modifications, document status, and other information corresponding to the project.

Further, as used herein, the term “update propagation communication” refers to a notification including information about a change to a digital content item. In one or more embodiments, the content item embedding information system generates an update propagation communication in response to one or more modifications to content items corresponding to a project. In some embodiments, an update propagation communication includes information extracted from an updated document. Further, in one or more embodiments, the content item embedding information system addresses and/or sends an update propagation communication to one or more teams indicated by an information flow pattern.

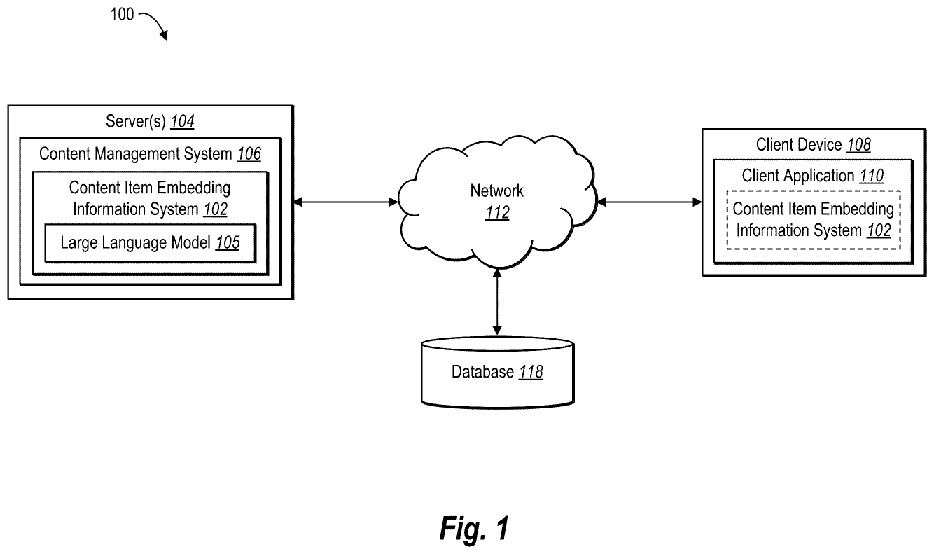

Additional detail regarding the content item embedding information system will now be provided with reference to the figures. For example, FIG. 1 illustrates a schematic diagram of an example system environment 100 for implementing a content item embedding information system 102 in accordance with one or more implementations. An overview of the content item embedding information system 102 is described in relation to FIG. 1. Thereafter, a more detailed description of the components and processes of the content item embedding information system 102 is provided in relation to the subsequent figures.

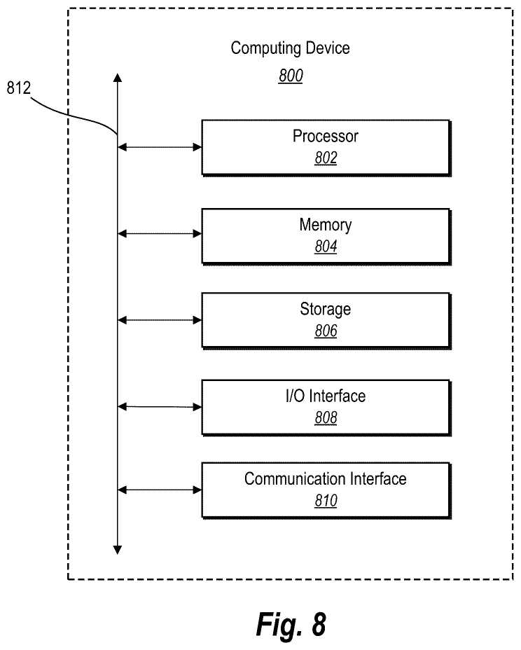

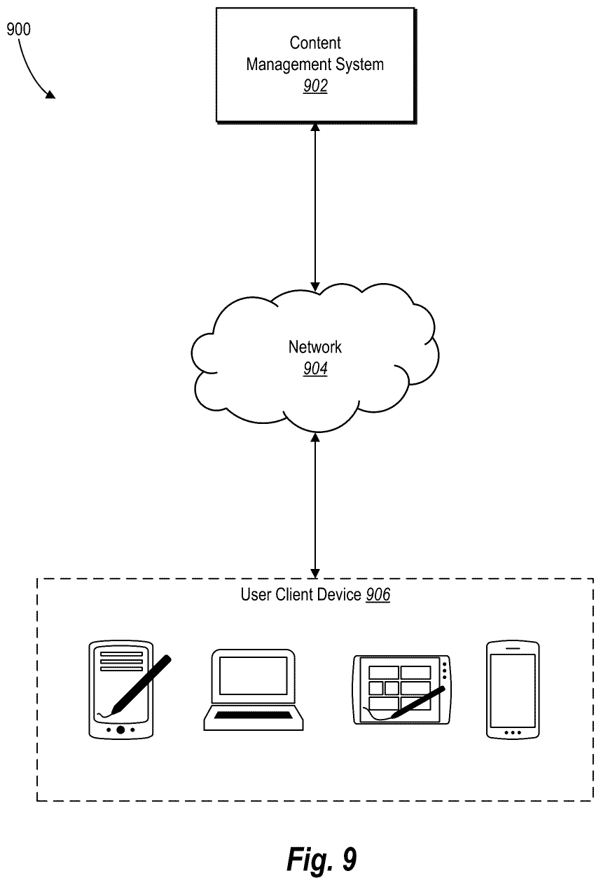

As shown, the environment 100 includes server(s) 104, client device 108, a database 118, and a network 112. Each of the components of the environment 100 can communicate via the network 112, and the network 112 may be any suitable network over which computing devices can communicate. Example networks are discussed in more detail below in relation to FIGS. 8-9.

As mentioned above, the example environment 100 includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 8-9. The client device 108 can communicate with the server(s) 104 via the network 112. For example, the client device 108 can receive user input from a user interacting with the client device 108 (e.g., via the client application 110) to, for instance, access, generate, modify, or share a content item, to collaborate with a co-user of a different client device, or to select a user interface element. In addition, the content item embedding information system 102 on the server(s) 104 can receive information relating to various interactions with content items and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including content items, information flow patterns, update propagation communications, and/or project report documents.

As illustrated in FIG. 1, the example environment 100 also includes the server(s) 104. The server(s) 104 may generate, track, store, process, receive, and transmit electronic data, such as digital content (e.g., content items), information flow patterns, update propagation communications, project report documents, and/or interactions between user accounts or client devices. For example, the server(s) 104 may receive data from the client device 108 in the form of a modification to a project document, approval of an update propagation communication, approval of a suggested modification, etc. In addition, the server(s) 104 can transmit data to the client device 108 in the form of notifications, update propagation communications, project report documents, etc. Indeed, the server(s) 104 can communicate with the client device 108 to send and/or receive data via the network 112. As shown, the server(s) 104 can also include a large language model 105 that is native to, housed or hosted on, and/or maintained by the content management system 106. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers. In addition, in one or more embodiments, the large language model may be hosted elsewhere, including on a client device (e.g., the client device 108) or a third-party server.

As shown in FIG. 1, the server(s) 104 can also include the content item embedding information system 102 as part of a content management system 106. The content management system 106 can communicate with the client device 108 to perform various functions associated with the client application 110 such as managing user accounts, managing content collections, managing content items, and facilitating user interaction with the content collections and/or content items. Indeed, the content management system 106 can include a network-based smart cloud storage system to manage, store, and maintain content items and related data across numerous user accounts, including user accounts in collaboration with one another. In some embodiments, the content item embedding information system 102 and/or the content management system 106 utilize a database 118 to store and access information such as digital content items, project information, communications, information flow patterns, etc.

Although FIG. 1 depicts the content item embedding information system 102 located on the server(s) 104, in some implementations, the content item embedding information system 102 may be implemented by (e.g., located entirely or in part on) one or more other components of the environment 100. For example, the content item embedding information system 102 may be implemented by the client device 108 and/or a third-party device. For example, the client device 108 can download all or part of the content item embedding information system 102 for implementation independent of, or together with, the server(s) 104.

In some implementations, though not illustrated in FIG. 1, the environment 100 may have a different arrangement of components and/or may have a different number or set of components altogether. For example, the client device 108 may communicate directly with the content item embedding information system 102, bypassing the network 112. As another example, the environment 100 can include the database 118 located external to the server(s) 104 (e.g., in communication via the network 112) or located on the server(s) 104, on a third-party system, and/or on the client device 108.

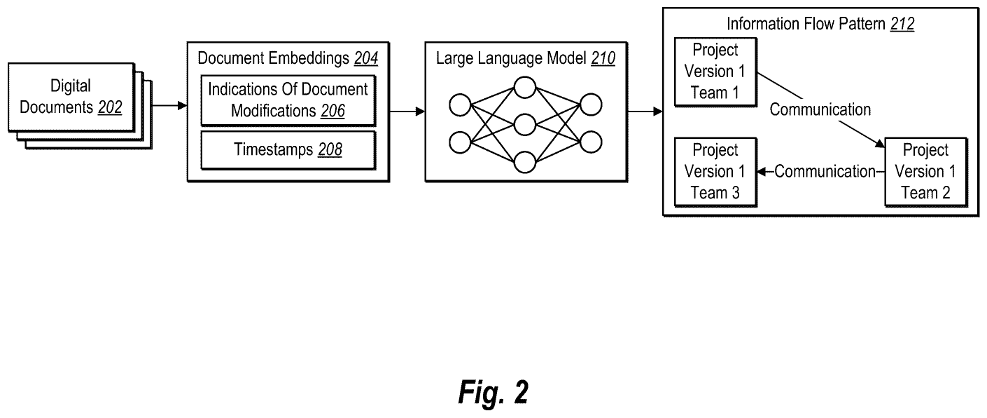

As discussed above, the content item embedding information system 102 can generate an information flow pattern for a content item embedding. In particular, the content item embedding information system 102 can utilize a large language model to generate or predict an information flow pattern from one or more content items. FIG. 2 illustrates an overview of the process of generating an information flow pattern in accordance with one or more embodiments.

As shown in FIG. 2, in one or more embodiments, the content item embedding information system 102 utilizes digital documents 202 as a basis for generating information flow patterns. In some embodiments, the content item embedding information system 102 utilizes a variety of content item types, such as applications, documents, images, digital communications, or other content types enumerated above. However, the digital documents 202 are shown by way of example. Likewise, the document embeddings 204 are an example of content item embeddings for illustrative purposes.

In some embodiments, the content item embedding information system 102 receives or retrieves the digital documents 202 from a database of project documents. In some embodiments, the digital documents 202 include metadata indicating associated projects, modifications, prior versions, attachments, creator accounts, and/or collaborating accounts. As shown in FIG. 2, in one or more embodiments, the content item embedding information system 102 generates document embeddings 204 based on the digital documents 202. In some embodiments, the content item embedding information system 102 extracts the document embeddings 204 from the metadata of the digital documents 202. In some cases, the content item embedding information system 102 uses the large language model 210 to generate or extract the document embeddings 204.

As shown in FIG. 2, the document embeddings 204 include indications of document modifications 206 and timestamps 208. In one or more embodiments, the indications of document modifications 206 include the content of the modification, user data associated with the modification, indications of user input associated with the modification, and/or metadata associated with the modification. Further, the content item embedding information system 102 can associate the indications of document modifications 206 with their corresponding timestamps 208. In one or more embodiments, the content item embedding information system 102 extracts content, storage or organizational data, metadata, or other data to generate the document embeddings 204. Accordingly, in one or more embodiments, the document embeddings 204 can include project data indicating a project corresponding to the content item embedding, version data indicating a version of the content item at the time of the content item embedding, and/or team data corresponding to a team that generated and/or modified the content item.

In one or more embodiments, the content item embedding information system 102 can also extract and utilize other content item data (e.g., other than content item embeddings). To illustrate, the content item embedding information system 102 can utilize content item embeddings or content item data otherwise encodes or indicates timestamp and modification data without embedding in an embedding. For instance, the content item embedding information system 102 can generate a prompt that indicates modification data and/or a timestamp in text form, as interpretable by a large language model. Additionally, in one or more embodiments, the content item embedding information system 102 can utilize additional content item data in combination with a content item embedding. Accordingly, the content item embedding information system 102 can utilize a variety of content item data in combination with a large learning model to determine information flow patterns.

As also shown in FIG. 2, in one or more embodiments, the content item embedding information system 102 inputs the document embeddings 204 (and/or the digital documents 202) into a large language model 210. In one or more embodiments, the large language model 210 processes the content of the digital documents 202 for references to other documents. Additionally, in some embodiments, the large language model 210 analyzes the document embeddings 204 for patterns in similar changes, changes referenced in communications, transmissions of the modifications and/or the digital documents 202, and other connections to generate information flow patterns for various projects for the digital documents 202. Thus, the content item embedding information system 102 can generate a set of information flow patterns corresponding to a database of digital documents 202.

As shown in FIG. 2, in one or more embodiments, the content item embedding information system 102 generates an information flow pattern 212 based on the analysis of the large language model 210. In FIG. 2, the information flow pattern 212 includes document embeddings 204 including “Project, Version 1, Team 1,” “Project, Version 1, Team 2,” and “Project, Version 1, Team 3.” Additionally, the information flow pattern 212 includes two communication embeddings from the document embeddings 204. However, the information flow pattern 212 is shown by way of example, and the content item embedding information system 102 can generate an information flow pattern with a variety of different configurations and numbers of content item embeddings based on the data provided to and received from the large language model 210.

In one or more embodiments, the information flow pattern 212 can include a text description of the flow of information during a project. More specifically, in some embodiments, the information flow pattern 212 is a text description of which content items are transmitted and what user accounts send or receive content items. Further, the information flow pattern 212 can include a text description of what changes should be made to which documents. The information flow pattern 212 can also include team information for the user accounts and/or the documents designated for modification. In addition, the information flow pattern 212 can include one or more communications or notifications to send, including content of such communications. In one or more embodiments, the large language model 210 generates the description-based version of the flow pattern from document embeddings in the form of text descriptions of the modifications, their timestamps, and their transmission between accounts.

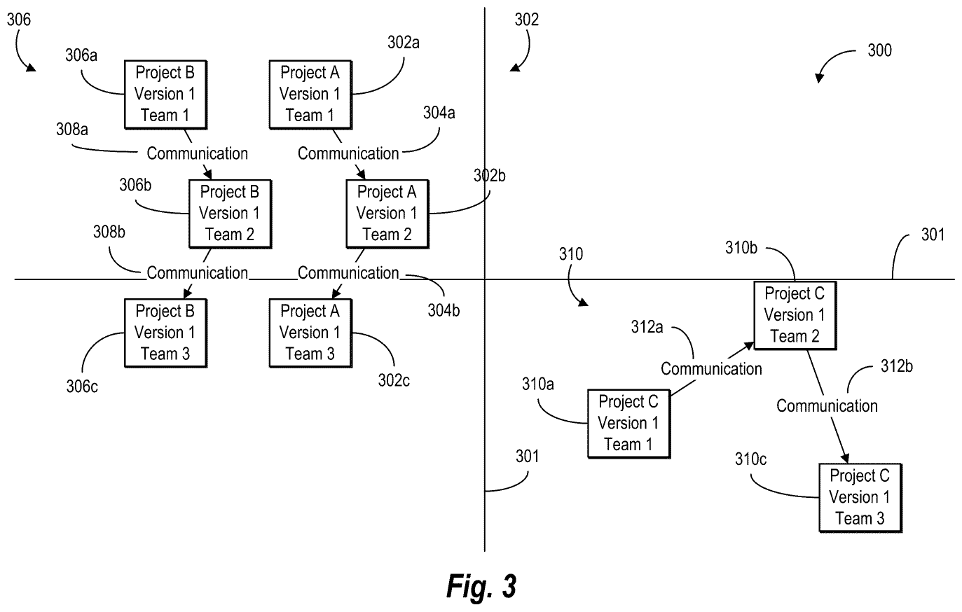

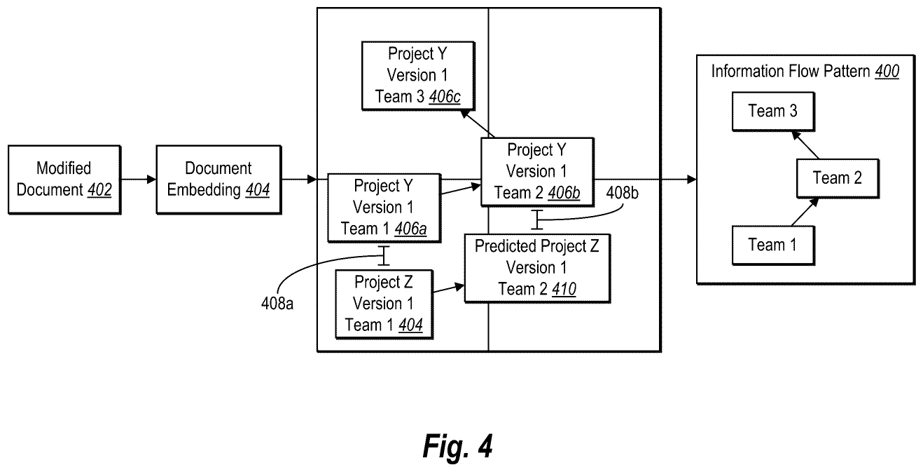

In one or more embodiments, the content item embedding information system 102 can determine an information flow pattern for a target digital document with a target modification, and consequently, a target document embedding. As will be discussed in greater detail with regard to FIGS. 3-4, in one or more embodiments, the content item embedding information system 102 determines the information flow pattern 212 as a cumulative or combined information flow pattern utilizing information flow patterns generated from processing a large set of digital documents 202. To illustrate, in one or more embodiments, the content item embedding information system 102 compares a document embedding to a variety of other document embeddings (within a threshold similarity of one another and/or belonging to a shared project-specific cluster in the embeddings space) to generate or match an information flow pattern.

In addition, or in the alternative, the content item embedding information system 102 can directly input a target content item embedding into a machine learning model to generate the information flow pattern 212. In some embodiments, the content item embedding information system 102 inputs the target content item embedding the large language model 210 to generate the information flow pattern 212. In some embodiments, the content item embedding information system 102 utilizes the same large language model to both (1) process the historical documents to build the initial collection of information flow patterns, and (2) process a target content item embedding to generate a cumulative or combined information flow pattern from the collection. In addition, or in the alternative, the content item embedding information system 102 utilizes different models for these two tasks.

To illustrate, in some embodiments, the content item embedding information system 102 utilizes an additional machine learning model. That is, the content item embedding information system 102 can utilize machine learning models, including large language models, for various purposes. In one or more embodiments, the content item embedding information system 102 can train a machine learning model to generate information flow patterns for a target content item embedding. In one or more embodiments, a target content item embedding is a content item embedding for which the content item embedding information system 102 determines to generate an information flow pattern (e.g., as requested by a user account via a client device). In some embodiments, the content item embedding information system 102 identifies target content item embeddings based on detecting any modification. In addition, or in the alternative, the content item embedding information system 102 can receive a target content item embedding via user input flagging a modification.

To illustrate, the content item embedding information system 102 can train a machine learning model on information flow pattern data that indicates a ground truth information flow pattern corresponding to particular content item embeddings. Thus, in one or more embodiments, the content item embedding information system 102 can input a target content item embedding into the machine learning model and receive an information flow pattern. In one or more embodiments, the content item embedding information system 102 can train and utilize a large language model, a recurrent neural network, a long short-term memory neural network, or another machine learning model.

As mentioned above, in one or more embodiments, the content item embedding information system 102 utilizes a set of information flow patterns to generate an information flow pattern for a target content item. In some embodiments, the content item embedding information system 102 determines similarities between a target content item embedding and the content item embeddings corresponding to a set of information flow patterns. In one or more embodiments, the content item embedding information system 102 utilizes an embedding space to determine similarities between information flow patterns and content item embeddings. FIG. 3 illustrates an example embedding space 300 with information flow patterns mapped along an axis 301 in accordance with one or more embodiments. While FIG. 3 illustrates the embedding space 300 as two-dimensional for ease of illustration, the content item embedding information system 102 can utilize a multi-dimensional embedding space that accounts for a variety of factors.

As shown in FIG. 3, each of the content items 302a-302c, 306a-306c, 310a-310d include one or more content item embeddings indicating modifications to the documents and one or more corresponding timestamps. In one or more embodiments, the projects corresponding to the information flow pattern 306, the information flow pattern 310, and the information flow pattern 310 can include a single content items or a variety of content items. For example, an information flow pattern can include a single content item modified by a variety of teams. In another example, an information flow pattern can include multiple content items worked on by multiple user accounts on various teams.

As shown in FIG. 3, the information flow pattern 302, the information flow pattern 306, and the information flow pattern 310 include data indicating a project, a team, a content item version, and an order in time. Further, each of the communications 304a-304b, 308a-208b, 312a-312b include communication data and a corresponding timestamp. Thus, the information flow patterns 302, 306, 310 show a map through time of communications between teams and modifications to project documents, where Team 3 is last to receive Version 1 of a given project and where Version 1 may be obsolete by the time Team 3 receives it (e.g., based on creation of a Version 2 by Team 1). The content item embedding information system 102 can, accordingly, generate an information flow pattern to include information about how, where, and when modifications are made to project content items relative to one another and relative to other information flow patterns.

For example, as shown in FIG. 3, the embedding space 300 includes an information flow pattern 302 for Project A including content items 302a-302c and communications 304a-304b, an information flow pattern 306 for Project B including content items 306a-306c and communications 308a-308b, and an information flow pattern 310 for Project C including content items 310a-310c and communications 312a-312b. More specifically, the information flow pattern 302 includes content item 302a indicating “Project A Version 1 Team 1” preceding the communication 304a from Team 1 to Team 2. Following the communication 304a, the information flow pattern 302 includes the content item 302b indicating “Project A Version 1 Team 2” preceding the communication 304b from Team 2 to Team 3. Following the communication 204b, the information flow pattern 302 includes the content item 302 indicating “Project A Version 1 Team 3.”

Additionally, the content item embedding information system 102 maps the information flow patterns on the axis 301 based on other attributes, such as content item type, the body of a content item, sender and recipient information in a communication, lengths of time between modifications, and a variety of other content item data. Thus, the content item embedding information system 102 can determine similarities and differences between content items and information flow patterns along a variety of different dimensions and respects.

As shown in FIG. 3, the information flow pattern 302 is similar in trajectory and type to the information flow pattern 306. However, both the information flow pattern 302 and the information flow pattern 306 are dissimilar in trajectory and type to the information flow pattern 310. In one or more embodiments, the content item embedding information system 102 utilizes two or more similar information flow patterns to generate an archetype information flow pattern. To illustrate, the content item embedding information system 102 can determine that two or more information flow patterns satisfy a threshold similarity threshold with regard to one another.

For example, as shown in FIG. 3, the content item embedding information system 102 can determine that the distance in the embedding space 300 between the content item embeddings and/or the trajectory and/or shape of the communications of the information flow pattern 302 and the information flow pattern 306 satisfy a similarity threshold (e.g., within the embedding space 300). Indeed, the vectors of the embedded communications in the embedding space 300 have different trajectories or directions indicating transmittal between teams or accounts (where the teams/accounts are located in particular coordinate locations of the embedding space 300). The embedded communications also have different lengths indicating time between receipt and transmittal of a project/item version (e.g., where longer lines indicate a longer time from when a team receives a version to when the team provides that version to the next team). Based on the distance(s), trajectories, lengths, and/or shapes satisfying a similarity threshold, the content item embedding information system 102 can generate an archetype information flow pattern.

As discussed above, in addition to mapping historical information flow patterns in an embedding space, the content item embedding information system 102 can utilize an embedding space to generate an information flow pattern for a target content item embedding. In particular, the content item embedding information system 102 can compare a target content item embedding with other content item embeddings to determine which, if any, satisfy a similarity threshold for predicting the information flow pattern of the target content item. FIG. 4 illustrates a process for generating an information flow pattern 400 in response to identifying a modification to a target content item in accordance with one or more embodiments.

As shown in FIG. 4, in response to identifying a modified document 402 (e.g., a target content item), the content item embedding information system 102 generates a document embedding 404. As discussed above, the content item embedding information system 102 extracts one or more indications of document modifications and corresponding timestamps to generate the document embedding 404. In some embodiments, the content item embedding information system 102 generates the document embedding 404 as a data package including the one or more indications of document modifications and corresponding timestamps.

In addition, or in the alternative, in one or more embodiments the document embedding 404 can include indications of the creation and/or transmission of a content item and corresponding timestamps. Accordingly, in one or more embodiments, the content item embedding information system 102 can generate an information flow pattern in response to identifying creation of a content item and/or transmission of the content item from one account or team to another. Thus, the content item embedding information system 102 can utilize a newly created document to determine future communications, documents, and modifications likely to relate to the project corresponding to the created document.

As shown in FIG. 4, the content item embedding information system 102 can map the document embedding 404 in an embedding space. The content item embedding information system 102 utilizes version, project, timestamp, and team data from the document embedding 404 to map it in the embedding space as “Project Z Version 1 Team 1.” As discussed above, the document embedding 404 can include project data indicating a project corresponding to the content item embedding, version data indicating a version of the content item at the time of the content item embedding, and/or team data corresponding to a team that generated and/or modified the content item.

As further shown in FIG. 4, the content item embedding information system 102 can compare the document embedding 404 to other document embeddings in information flow patterns. For example, the content item embedding information system 102 can compare the document embedding 404 to a variety of content item embeddings generated by providing content items embeddings to a large language model, as discussed above with regard to FIG. 2. More specifically, as shown in FIG. 4, the content item embedding information system 102 compares the document embedding 404 to the content item embeddings 406a-406c. As shown in FIG. 4, the content item embedding 406a is mapped as “Project Y, Version 1, Team 1,” the content item embedding 406a is mapped as “Project Y, Version 1, Team 2,” and the content item embedding 406a is mapped as “Project Y, Version 1, Team 3.”

In one or more embodiments, the content item embedding information system 102 determines distances between content item embeddings in the embedding space and the document embedding 404. Accordingly, the content item embedding information system 102 can utilize these distances to identify the closest content item embeddings and their corresponding projects. For example, as shown in FIG. 4, the content item embedding information system 102 determines that the closest content item embedding to the document embedding 404 is the content item embedding 406a by determining that the distance 408a is the lowest distance between the document embedding 404 and other content item embeddings in the embedding space (and that the distance satisfies a similarity threshold for indicating similar content items).

As discussed above, based on identified content item embeddings and projects, the content item embedding information system 102 can determine an information flow pattern 400 for the document embedding 404. To illustrate, the content item embedding information system 102 can determine the closest content item embedding to a target content item embedding and utilize an information flow pattern corresponding to the nearby content item embedding to generate an information flow pattern for the target content item embedding. For example, as shown in FIG. 4, the content item embedding information system 102 can identify the information flow pattern corresponding to the content item embedding 406a to generate an information flow pattern for the document embedding 404.

In one or more embodiments, the content item embedding information system 102 identifies teams associated with the close-by information flow pattern to generate a target information flow pattern. For example, the content item embedding information system 102 can identify that Team 2 and Team 3 are associated with the content item 406b and the content item 406c. Based on this identification, as shown in FIG. 4, the content item embedding information system 102 can include Team 2 and Team 3 in the information flow pattern for the document embedding 404.

In addition, or in the alternative, the content item embedding information system 102 can utilize a similarity threshold for distances within the embedding space. To illustrate, the content item embedding information system 102 can determine whether a closest distance between a target content item embedding and another content item embedding satisfies the similarity threshold before utilizing the closet content item embedding. Thus, the content item embedding information system 102 can avoid inaccurate results or suggestions for target content item embeddings with no close results.

In addition, or in the alternative, the content item embedding information system 102 can utilize a similarity threshold to identify all content item embeddings within a threshold distance of the target content item embedding information system 102. Accordingly, the content item embedding information system 102 can utilize all content item embeddings that satisfy the similarity threshold to determine an information flow pattern for the target content item embedding. For example, the content item embedding information system 102 can generate the information flow pattern to include all teams in any information flow pattern within the threshold distance. In another example, the content item embedding information system 102 can average the determined information flow patterns in both trajectory and included teams. In such an example, the content item embedding information system 102 can include teams or communications in the information flow pattern that are present in a threshold portion (e.g., at least half) of the determined information flow patterns.

As discussed above with regard to FIG. 3, in one or more embodiments, the content item embedding information system 102 generates one or more archetype information flow patterns based on similar information flow patterns from a historical set of content item embeddings. In one or more embodiments, the content item embedding information system 102 identifies an archetype information flow pattern for a target content item embedding by determining the nearest archetype content item embedding within the embedding space. Accordingly, the content item embedding information system 102 can generate the information flow pattern using the archetype information flow pattern as a template.

In one or more embodiments, the content item embedding information system 102 can determine that the document embedding 404 is different with respect to one or more attributes or dimensions within the embedding space from the one or more content item embeddings that the content item embedding information system 102 is using to determine the information flow pattern 410. More specifically, as shown in FIG. 4, the content item embedding information system 102 determines the distance and directionality of the document embedding 404 from the content item embedding 406a.

Thus, as shown in FIG. 4, the content item embedding information system 102 can generate the information flow pattern 400 including the content item embedding 410, mapped as “Predicted Project Z, Version 1, Team 2” with the same distance and directionality 408b measured from the content item embedding 406b. Similarly, in one or more embodiments, the content item embedding information system 102 can generate a number of predicted steps for the information flow pattern based on the identified similar information flow pattern(s). Additionally, though FIG. 4 illustrates one predicted step corresponding to the content item embedding 406b, the content item embedding information system 102 can generate a number of predicted content item embeddings for a generated information flow pattern all at one time. In addition, or in the alternative, the content item embedding information system 102 can generate the predicted content item embeddings for an information flow pattern over time in response to additional received target document embeddings in the same project. Further, in one or more embodiments, the content item embedding information system 102 can generate the predicted content item embeddings for an information flow pattern over time in response to user rejection or approval of prior predictions.

Thus, the content item embedding information system 102 can generate the information flow pattern 400 including predicted content embeddings. That is, the content item embedding information system 102 generates the information flow pattern 400 including projected changes to content items. That is, the content item embedding information system 102 determines the predicted content item embeddings based on similar changes to similar content items from historical information flow patterns. Further, the content item embedding information system 102 can generate the information flow pattern 400 including one or more communications between teams. That is, the content item embedding information system 102 determines the predicted communications between teams based on communications between teams from historical information flow patterns.

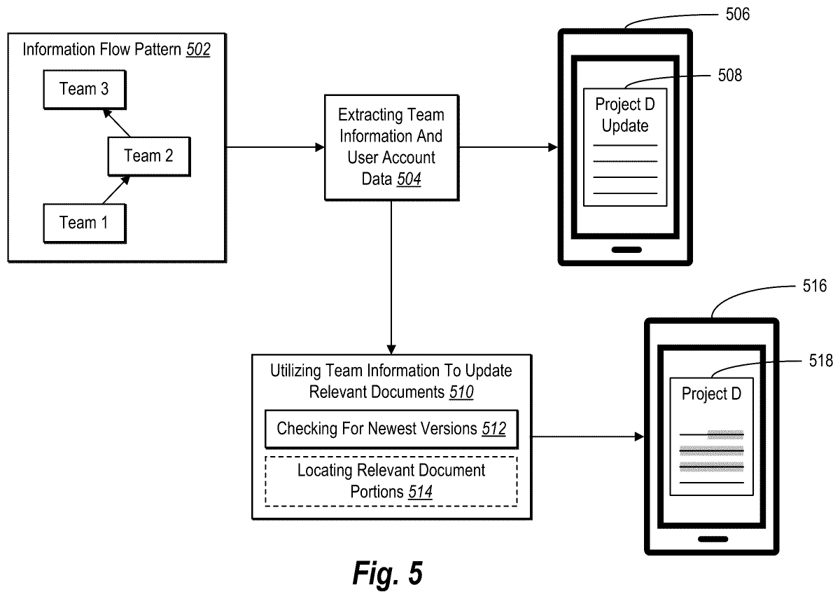

As discussed above, in one or more embodiments, the content item embedding information system 102 can generate communications based on a determined information flow pattern. FIG. 5 illustrates an example process for utilizing an information flow pattern 502 to generate an update propagation communication and/or a project report document in accordance with one or more embodiments. Further, FIG. 5 illustrates utilizing an information flow pattern 502 to update relevant documents in accordance with one or more embodiments.

As shown in FIG. 5, the information flow pattern 502 includes content item embeddings for Team 1, Team 2, and Team 3. Further, the information flow pattern 502 includes a communication between Team 1 and Team 2, and a communication between Team 2 and Team 3. Further, as shown in FIG. 5, the content item embedding information system 102 can perform an act 504 of extracting team information and user account data. More specifically, in one or more embodiments, the content item embedding information system 102 determines the team data from the information flow pattern 502. To illustrate, in one or more embodiments, the content item embedding information system 102 generates an information flow pattern including data that suggests a recipient team and/or user account for a communication between teams.

Accordingly, the content item embedding information system 102 can retrieve user account data and/or contact information corresponding to the information flow pattern 502. For example, if the information flow pattern 502 includes an email communication between the Team 1 lead and the Team 2 lead, the content item embedding information system 102 can utilize an organization account directory to retrieve email addresses for the Team 1 lead and the Team 2 lead. In another example, if the information flow pattern includes modifications to an application belonging to Team 2 and a slide presentation corresponding to Team 3, the content item embedding information system 102 can identify such content items in a cloud computing network corresponding to the organization account for the information flow pattern 502.

In one or more embodiments, the content item embedding information system 102 can utilize this extraction to run a check on the accuracy of the information flow pattern. For example, if the information flow pattern indicates a future modification to a word document belonging to Team 3 with a file name similar to “Q3 Marketing Updates,” but no such word document exists, the content item embedding information system 102 can determine that the predicted information flow pattern is likely to be in error, and can discontinue recommendations based on that information flow pattern.

Upon extracting the indicated content items, user account data, and/or contact information, the content item embedding information system 102 can generate a communication 508 from the information flow pattern and provide the communication 508 to a user device 506 associated with a determined user account. To illustrate, the content item embedding information system 102 utilizes the information flow pattern to generate a communication, including contact information, subject line information, body information, and data from the initial target content item embedding.

In one or more embodiments, the content item embedding information system 102 generates an update propagation communication. To illustrate, the content item embedding information system 102 can identify a communication from the information flow pattern 502 and determine contact information for the one or more user accounts indicated by the information flow pattern 502. Further, in one or more embodiments, the content item embedding information system 102 detects a communication format corresponding to the second team from the information flow pattern 502. Thus, the content item embedding information system 102 can generate the update propagation communication utilizing the communication format and inserting the contact information and data from an initial modification prompting the information flow pattern 502.

Additionally, in one or more embodiments, the content item embedding information system 102 generates a project report document that continually updates relevant teams as to important modifications within a project. To illustrate, in one or more embodiments, the content item embedding information system 102 identifies teams from the information flow pattern. Further, the content item embedding information system 102 can generate a project report document including information from the first document relevant to the second team and the one or more additional teams. In some embodiments, the content item embedding information system 102 determines information relevant to the teams based on projected content for communications in the information flow pattern. In addition, or in the alternative, the content item embedding information system 102 determines information relevant to the teams based on the initial content item embedding and/or projected content item embeddings within the information flow pattern.

In one or more embodiments, the content item embedding information system 102 provides digital access to the project report document to user accounts associated with the teams from the information flow pattern. Additionally, the content item embedding can continuously update the project report document in real-time based on further modifications to project documents. To illustrate, the content item embedding information system 102 can modify the project report document in response to automatic modifications made by the content item embedding information system 102 and/or manual modifications. In one or more embodiments, the content item embedding information system 102 can provide notifications to the user accounts associated with the teams from the information flow patterns in response to such updates.

Additionally, in one or more embodiments, the content item embedding information system 102 can generate an update propagation communication and/or a project report document including recommendations of actions to take. For example, in one or more embodiments, the content item embedding information system 102 can utilize a large language model to generate information flow patterns including additional actions, such as generating new projects, scheduling meetings, scheduling events, and/or other actions indicated by project documents provided to the large language model. Accordingly, the content item embedding information system 102 can generate new information flow patterns for target content item embeddings including these additional actions. Thus, in one or more embodiments, the content item embedding information system 102 can generate communications that recommend these actions to recipient teams and user accounts. For example, if an information flow pattern indicates a meeting between two teams the content item embedding information system 102 can generate a meeting invitation including text describing a content item modification relevant to the two teams, and inviting user accounts indicated by the information flow pattern.

Similarly, in one or more embodiments, the content item embedding information system 102 can teams included in an information flow pattern as “collaborators” and/or “stakeholders” or as otherwise relevant teams to a project. Based on this identification, the content item embedding information system 102 can determine communications and/or actions for each team or user account identified as a stakeholder for the project. Accordingly, the content item embedding information system 102 can ensure that each relevant team or user account is included in relevant actions and/or communications.

As also shown in FIG. 5, the content item embedding information system 102 can perform an act 510 of utilizing team information to update relevant documents. More specifically, in one or more embodiments, the content item embedding information system 102 identifies one or more projected content item embeddings in the information flow pattern. Accordingly, the content item embedding information system 102 can extract projected modifications to content items from the content item embeddings. Based on these content item embedding, the content item embedding information system 102 can identify relevant documents and determine modifications for those documents. Thus, in one or more embodiments, the content item embedding information system 102 can automatically implement the projected changes to the one or more documents.

In one or more embodiments, the content item embedding information system 102 can provide a proposed amendment to one or more user accounts associated with the relevant document. In response to approval, the content item embedding information system 102 can implement the change. In addition, or in the alternative, the content item embedding information system 102 can automatically modify a content item and then provide a notification of the change, as described above with regard to the project report document.

For example, as shown in FIG. 5, the content item embedding information system 102 can provide a graphical user interface 518 to a user device 516. As shown in FIG. 5, the graphical user interface includes a project and highlighted modifications. In one or more embodiments, the content item embedding information system 102 can further request approval for such modifications. For example, the content item embedding information system 102 can remove the highlight upon acceptance of a modification. Though FIG. 5 illustrates a highlight to indicate a modification, it will be appreciated that the content item embedding information system 102 can denote modifications in a variety of ways, such as underlining, arrows, color differences, or other visual indicators.

As also shown in FIG. 5, the act 510 can include an act 512 of checking for newest versions. To illustrate, in one or more embodiments, the content item embedding information system 102 can verify that a modification triggering changes to other documents is newer than the newest version of a document selected for modification. If the document selected for modification is newer, the content item embedding information system 102 can determine not to implement the modification. In addition, or in the alternative, the content item embedding information system 102 can compare whether the relevant portion of the document is newer than the triggering modification.

To illustrate, as shown in FIG. 5, the act 510 can include an optional act 514 of locating relevant document portions. More specifically, in one or more embodiments, the content item embedding information system 102 identifies a region surrounding a targeted modification to synchronize with another document. In one or more embodiments, the content item embedding information system 102 generates an information flow pattern to include a target portion based on modified regions of content items in historical information flow patterns. Additionally, in one or more embodiments, the content item embedding information system 102 determines portions the documents indicated by the information flow pattern that are relevant to the project corresponding to the initial modification.

Accordingly, in one or more embodiments, the content item embedding information system 102 can, in response to identifying a modification, identify a related document from a content item embedding in the information flow pattern 502 for modification. Further, in one or more embodiments, the content item embedding information system 102 compares the modification of the first document with a related portion of the selected document to determine that the initial modification is newer than the newest version of the relevant portion of the selected content item. Additionally, in one or more embodiments, the content item embedding information system 102 can modify the related portion of the related document corresponding to the second team to reflect the first modification based on the determination that the initial modification is newer than the relevant portion of the content item selected for modification.

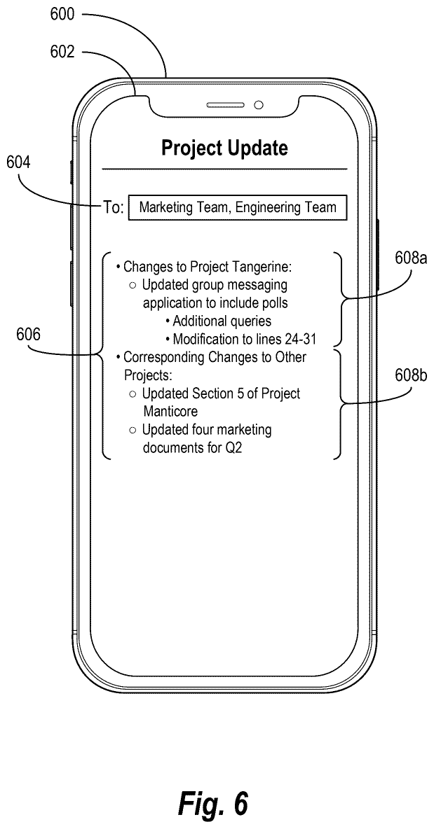

As mentioned above, in one or more embodiments, the content item embedding information system 102 can generate a communication reflecting one or more updates relevant to a project. FIG. 6 illustrates an example communication 602 on a user device 600 in accordance with one or more embodiments. The content item embedding information system 102 can present the communication 602 as an update propagation communication and/or a project report.

As shown in FIG. 6, the content item embedding information system 102 generates the communication 602 titled “Project Update.” Further, the content item embedding information system 102 generates the communication 602 to include an address bar 604. As shown in FIG. 6, the address bar 604 indicates sending to “Marketing Team, Engineering Team.” As discussed above, in one or more embodiments, the content item embedding information system 102 provides project communications to one or more teams indicated by an information flow pattern. Accordingly, the content item embedding information system 102 can address a project communication to teams or individual contact information indicated by an information flow pattern.

Further, FIG. 6 illustrates that the content item embedding information system 102 generates the communication 602 including the body 606, with section 608a-608b. However, as discussed above with regard to FIG. 5, the content item embedding information system 102 can generate a communication in a variety of formats, such as an essay, a list, headings with paragraphs, or other written communication formats. In some embodiments, the content item embedding information system 102 determines a format for a communication based on the team receiving the communication. For example, a team can implement a user setting requesting emails with bullet points. In another example, the content item embedding information system 102 can detect that another team primarily communicates with other teams via instant messages showing modifications directly, and can utilize that format based on identifying its historical usage.

In addition, or in the alternative, in one or more embodiments, a communication format for a team can include communication voice for that team. To illustrate, different departments or teams often have different vernacular, levels of formality, areas of focus, and/or tone typical for communications. For example, a developer teams might focus on different changes and describe them differently than a downstream marketing team. In some embodiments, the content item embedding information system 102 can utilize a format that specifies vernacular, levels of formality, and/or tone typical to that team. Thus, the content item embedding information system 102 can generate communications in the voice of the team.

As shown in FIG. 6, the section 608a reads “Changes to Project Tangerine: Updated group messaging application to include polls, additional queries, modification to lines 24-31” in bullet point format. Additionally, the section 608b reads “Corresponding Changes to Other Projects: Updated Section 5 of Project Manticore, Updated four marketing documents for Q2” in bullet point format. However, the content item embedding information system 102 can generate a variety of summaries and/or explanations for project communications. In one or more embodiments, the content item embedding information system 102 generates summaries of document modifications for project communications. In some embodiments, the content item embedding information system 102 uses a template and inserts extracted information from project documents.

In addition, or in the alternative, the content item embedding information system 102 can insert modified portions of documents into the communication. To illustrate, the content item embedding information system 102 can extract relevant portions from modified documents for inclusion in the document. In one or more embodiments, the content item embedding information system 102 can generate a heading for such modified portions.

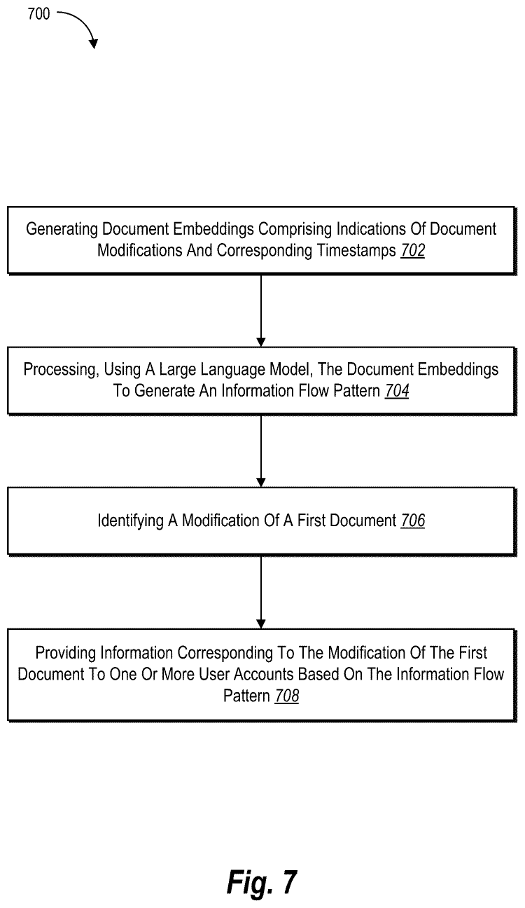

FIGS. 1-6, the corresponding text, and the examples provide a number of different methods, systems, devices, and non-transitory computer-readable media of the content item embedding information system 102. In addition to the foregoing, one or more embodiments can also be described in terms of flowcharts comprising acts for accomplishing a particular result, as shown in FIG. 7. FIG. 7 may be performed with more or fewer acts. Further, the acts may be performed in differing orders. Additionally, the acts described herein may be repeated or performed in parallel with one another or parallel with different instances of the same or similar acts.

As mentioned, FIG. 7 illustrates a flowchart of a series of acts 700 for generating and utilizing an information flow pattern in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer-readable medium can comprise instructions that, when executed by one or more processors, cause a computing device to perform the acts of FIG. 7. In some embodiments, a system can perform the acts of FIG. 7.

As shown in FIG. 7, the series of acts 700 includes an act 702 for generating document embeddings comprising indications of document modifications and corresponding timestamps. In particular, the act 702 can include generating document embeddings for digital documents shared within an organization account of a content management system, the document embeddings comprising indications of document modifications and corresponding timestamps.

Further, as shown in FIG. 7, the series of acts 700 includes an act 704 for processing, using a large language model, the document embeddings to generate an information flow pattern. In particular, the act 704 can include processing, using a large language model, the document embeddings to generate an information flow pattern between a first team and a second team within the organization account.

Also, as shown in FIG. 7, the series of acts 700 includes an act 706 for processing, using a large language model, the document embeddings to generate an information flow pattern. In particular, the act 706 can include identifying a modification of a first document associated with the first team.

Additionally, as shown in FIG. 7, the series of acts 700 includes an act 708 for providing information corresponding to the modification of the first document to one or more user accounts based on the information flow pattern. In particular, the act 708 can include providing information corresponding to the modification of the first document to one or more user accounts associated with the second team within the organization account based on the information flow pattern between the first team and the second team.

In some embodiments, the series of acts 700 also includes extracting content item data from content items shared within an organization account of a content management system, processing, using a large language model, the content item data to generate a plurality of information flow patterns corresponding to the content items, utilizing the plurality of information flow patterns to determine an information flow pattern between a first team and a second team within the organization account, identifying a modification of a first content item associated with the first team, and providing information corresponding to the modification of the first content item to one or more user accounts associated with the second team within the organization account based on the information flow pattern between the first team and the second team.

In one or more embodiments, the series of acts 700 also includes generating document embeddings for digital documents shared within an organization account of a content management system, the document embeddings comprising indications of document modifications and corresponding timestamps, processing, using a large language model, the document embeddings to generate an information flow pattern between a first team and a second team within the organization account, identifying a modification of a first document associated with the first team by analyzing a first document embedding comprising a first indication of the modification of the first document and a first corresponding timestamp, and providing information corresponding to the modification of the first document to one or more user accounts associated with the second team within the organization account based on the information flow pattern between the first team and the second team.

In some embodiments, the series of acts 700 include an act of, in response to identifying the modification of the first document, extracting a first document embedding (or other content item data) comprising a first indication of the modification of the first document and a first corresponding timestamp. Further, in one or more embodiments, the series of acts 700 includes an act of mapping the document embeddings into an embedding space, identifying, based on distances in the embedding space, one or more similar projects from the document embeddings for the digital documents, and determining the information flow pattern based on one or more information flow patterns corresponding to the one or more similar projects. In some embodiments, the series of acts 700 also includes identifying a similar project from the document embeddings (or other content item data) for the digital documents by determining that a distance between the document embeddings and additional document embeddings corresponding to the similar project satisfy a similarity threshold.

Additionally, in one or more embodiments, the series of acts 700 includes, in response to receiving the information flow pattern, generating an update propagation communication by extracting data relevant to the modification from the first document and relevant to the second team, and providing the update propagation communication to a user account associated with the first document. Further, in some embodiments, the series of acts 700 includes determining contact information for the one or more user accounts associated with the second team, detecting a communication format corresponding to the second team, and generating the update propagation communication in the communication format and comprising the contact information for the one or more user accounts associated with the second team. Also, in some embodiments, the series of acts 700 can include generating the information flow pattern in response to identifying a creation of the first document.

In some embodiments, the series of acts 700 further includes identifying one or more additional teams within the organization account based on the information flow pattern, generating a project report document comprising information from the first document relevant to the second team and the one or more additional teams, and providing digital access to the project report document to one or more user accounts associated with the first team, the one or more user accounts associated with the second team, and one or more user accounts associated with the one or more additional teams. Additionally, the series of acts 700 can include in response to identifying the modification of the first document, modifying a related document corresponding to the second team to reflect the modification of the first document, and providing a notification to the one or more user accounts associated with the second team.

In one or more embodiments, the series of acts 700 further includes identifying a related document corresponding to the first modification and the second team, and determining that the related document does not reflect the first modification. Additionally, the series of acts 700 can also include in response to modifying the related document, generating a project report document comprising a summary of automatic modification, and providing digital access to the project report document to user accounts associated with the first team and the second team.

In some embodiments, the series of acts 700 includes in response to receiving the information flow pattern, generate a communication by determining a portion of the first document relevant to the second team to extract data relevant to the modification from the first document. Further, the series of acts 700 can include in response to identifying the modification of the first document, identifying a related document corresponding to the first modification and the second team, identifying a related portion of the related document, comparing the modification of the first document with the related portion of the related document to determine that the modification of the first document is newer than a current state of the related portion of the related document, modifying the related portion of the related document corresponding to the second team to reflect the first modification, and providing a notification to the user accounts associated with the second team.

The components of the content item embedding information system 102 can include software, hardware, or both. For example, the components of the content item embedding information system 102 can include one or more instructions stored on a computer-readable storage medium and executable by processors of one or more computing devices. When executed by one or more processors, the computer-executable instructions of the content item embedding information system 102 can cause a computing device to perform the methods described herein. Alternatively, the components of the content item embedding information system 102 can comprise hardware, such as a special purpose processing device to perform a certain function or group of functions. Additionally or alternatively, the components of the content item embedding information system 102 can include a combination of computer-executable instructions and hardware.

Furthermore, the components of the content item embedding information system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the content item embedding information system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 (e.g., the server(s) 104 and/or the client device 108) that may be configured to perform one or more of the processes described above. One will appreciate that server(s) 104 and/or the client device 108 may comprise one or more computing devices such as computing device 800. As shown by FIG. 8, computing device 800 can comprise processor 802, memory 804, storage device 806, I/O interface 808, and communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other implementations. Furthermore, in certain implementations, computing device 800 can include fewer components than those shown in FIG. 8. Components of computing device 800 shown in FIG. 8 will now be described in additional detail.

In particular implementations, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular implementations, processor 802 may include one or more internal caches for data, instructions, or addresses. As an example and not by way of limitation, processor 802 may include one or more instruction caches, one or more data caches, and one or more translation lookaside buffers (TLBs). Instructions in the instruction caches may be copies of instructions in memory 804 or storage device 806.

Memory 804 may be used for storing data, metadata, and programs for execution by the processor(s). Memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (HDD), a floppy disk drive, flash memory, an optical disc, a magneto-optical disc, magnetic tape, or a Universal Serial Bus (USB) drive or a combination of two or more of these. Storage device 806 may include removable or non-removable (or fixed) media, where appropriate. Storage device 806 may be internal or external to computing device 800. In particular implementations, storage device 806 is non-volatile, solid-state memory. In other implementations, Storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 812 may include hardware, software, or both that couples components of computing device 800 to each other. As an example and not by way of limitation, communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 9 is a schematic diagram illustrating environment 900 within which one or more implementations of the content item embedding information system 102 can be implemented. For example, the content item embedding information system 102 may be part of a content management system 902 (e.g., the content management system 106). Content management system 902 may generate, store, manage, receive, and send digital content (such as digital content items). For example, content management system 902 may send and receive digital content to and from client devices 906 by way of network 904. In particular, content management system 902 can store and manage a collection of digital content. Content management system 902 can manage the sharing of digital content between computing devices associated with a plurality of users. For instance, content management system 902 can facilitate a user sharing a digital content with another user of content management system 902.

In particular, content management system 902 can manage synchronizing digital content across multiple client devices 906 associated with one or more users. For example, a user may edit digital content using client device 906. The content management system 902 can cause client device 906 to send the edited digital content to content management system 902. Content management system 902 then synchronizes the edited digital content on one or more additional computing devices.

In addition to synchronizing digital content across multiple devices, one or more implementations of content management system 902 can provide an efficient storage option for users that have large collections of digital content. For example, content management system 902 can store a collection of digital content on content management system 902, while the client device 906 only stores reduced-sized versions of the digital content. A user can navigate and browse the reduced-sized versions (e.g., a thumbnail of a digital image) of the digital content on client device 906. In particular, one way in which a user can experience digital content is to browse the reduced-sized versions of the digital content on client device 906.

Another way in which a user can experience digital content is to select a reduced-size version of digital content to request the full- or high-resolution version of digital content from content management system 902. In particular, upon a user selecting a reduced-sized version of digital content, client device 906 sends a request to content management system 902 requesting the digital content associated with the reduced-sized version of the digital content. Content management system 902 can respond to the request by sending the digital content to client device 906. Client device 906, upon receiving the digital content, can then present the digital content to the user. In this way, a user can have access to large collections of digital content while minimizing the amount of resources used on client device 906.

Client device 906 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 906 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 904.

Network 904 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 906 may access content management system 902.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating document embeddings for digital documents shared within an organization account of a content management system, the document embeddings comprising indications of document modifications and corresponding timestamps;
processing, using a large language model, the document embeddings to generate an information flow pattern between a first team and a second team within the organization account;
identifying a modification of a first document associated with the first team; and
providing information corresponding to the modification of the first document to one or more user accounts associated with the second team within the organization account based on the information flow pattern between the first team and the second team.

2. The computer-implemented method of claim 1, further comprising, in response to identifying the modification of the first document, extracting a first document embedding comprising a first indication of the modification of the first document and a first corresponding timestamp.

3. The computer-implemented method of claim 2, wherein processing the document embeddings further comprises:
mapping the document embeddings into an embedding space;
identifying, based on distances in the embedding space, one or more similar projects from the document embeddings for the digital documents; and
determining the information flow pattern based on one or more information flow patterns corresponding to the one or more similar projects.

4. The computer-implemented method of claim 3, further comprising:
in response to receiving the information flow pattern, generating an update propagation communication by extracting data relevant to the modification from the first document; and
providing the update propagation communication to a user account associated with the first document.

5. The computer-implemented method of claim 4, wherein generating the update propagation communication further comprises:
determining contact information for the one or more user accounts associated with the second team;
detecting a communication format corresponding to the second team; and
generating the update propagation communication in the communication format and comprising the contact information for the one or more user accounts associated with the second team.

6. The computer-implemented method of claim 1, further comprising:
identifying one or more additional teams within the organization account based on the information flow pattern;
generating a project report document comprising information from the first document relevant to the second team and the one or more additional teams; and
providing digital access to the project report document to one or more user accounts associated with the first team, the one or more user accounts associated with the second team, and one or more user accounts associated with the one or more additional teams.

7. The computer-implemented method of claim 1, further comprising:
in response to identifying the modification of the first document, modifying a related document corresponding to the second team to reflect the modification of the first document; and
providing a notification to the one or more user accounts associated with the second team.

8. A non-transitory computer-readable medium storing instructions that, when executed by at least one processor, cause a computer system to:
extract content item data from content items shared within an organization account of a content management system;
process, using a large language model, the content item data to generate a plurality of information flow patterns corresponding to the content items;
utilize the plurality of information flow patterns to determine an information flow pattern between a first team and a second team within the organization account;
identify a modification of a first content item associated with the first team; and
provide information corresponding to the modification of the first content item to one or more user accounts associated with the second team within the organization account based on the information flow pattern between the first team and the second team.

9. The computer-readable medium of claim 8, further comprising instructions that, when executed by the at least one processor, cause the computer system to, in response to identifying the modification of the first content item, extract content item data comprising a first indication of the modification of the first content item and a first corresponding timestamp.

10. The computer-readable medium of claim 9, further comprising instructions that, when executed by the at least one processor, cause the computer system to determine the information flow pattern by:
mapping the content item data into an embedding space;
identifying a similar project from the content item data for the content items by determining that a distance between the content item data and additional content item data corresponding to the similar project satisfy a similarity threshold; and
determining the information flow pattern based on one or more information flow patterns corresponding to the similar project.

11. The computer-readable medium of claim 10, further comprising instructions that, when executed by the at least one processor, cause the computer system to:
in response to receiving the information flow pattern, generate an update propagation communication by extracting data relevant to the modification from the first content item and relevant to the second team; and
provide the update propagation communication to a user account associated with the first content item.

12. The computer-readable medium of claim 11, further comprising instructions that, when executed by the at least one processor, cause the computer system to:
determine contact information for the one or more user accounts associated with the second team;
detect a communication format corresponding to the second team; and
generate the update propagation communication in the communication format and comprising the contact information for the one or more user accounts associated with the second team.

13. The computer-readable medium of claim 8, further comprising instructions that, when executed by the at least one processor, cause the computer system to:
in response to identifying the modification of the first content item, identify a related content item corresponding to the modification of the first content item and the second team;
determine that the related content item does not reflect the modification of the first content item;
modify the related content item to reflect the modification of the first content item; and
provide a notification to the one or more user accounts associated with the second team.

14. The computer-readable medium of claim 13, further comprising instructions that, when executed by the at least one processor, cause the computer system to:
in response to modifying the related content item, generate a project report document comprising a summary of automatic modifications; and
provide digital access to the project report document to one or more user accounts associated with the first team and the one or more user accounts associated with the second team.

15. A system comprising:
at least one processor; and
at least one non-transitory computer-readable storage medium storing instructions that, when executed by the at least one processor, cause the system to:
generate document embeddings for digital documents shared within an organization account of a content management system, the document embeddings comprising indications of document modifications and corresponding timestamps;
process, using a large language model, the document embeddings to generate an information flow pattern between a first team and a second team within the organization account;
identify a modification of a first document associated with the first team by analyzing a first document embedding comprising a first indication of the modification of the first document and a first corresponding timestamp; and
provide information corresponding to the modification of the first document to one or more user accounts associated with the second team within the organization account based on the information flow pattern between the first team and the second team.

16. The system of claim 15, further comprising instructions that, when executed by the at least one processor, cause the system to generate the information flow pattern in response to identifying a creation of the first document.

17. The system of claim 15, further comprising instructions that, when executed by the at least one processor, cause the system to:
map the document embeddings into an embedding space;
identify, based on distances in the embedding space, one or more similar projects from the document embeddings for the digital documents; and
determine the information flow pattern based on one or more information flow patterns corresponding to the one or more similar projects.

18. The system of claim 17, further comprising instructions that, when executed by the at least one processor, cause the system to:
in response to receiving the information flow pattern, generate an update propagation communication by determining a portion of the first document relevant to the second team to extract data relevant to the modification from the first document;
provide the update propagation communication to a user account associated with the first document;
determine contact information for the one or more user accounts associated with the second team;
detect a communication format corresponding to the second team; and
generate the update propagation communication in the communication format and comprising the contact information for the one or more user accounts associated with the second team.

19. The system of claim 15, further comprising instructions that, when executed by the at least one processor, cause the system to:
in response to identifying the modification of the first document, identify a related document corresponding to the modification of the first document and the second team;
identify a related portion of the related document;
compare the modification of the first document with the related portion of the related document to determine that the modification of the first document is newer than a current state of the related portion of the related document;
modify the related portion of the related document corresponding to the second team to reflect the modification of the first document; and
provide a notification to the one or more user accounts associated with the second team.

20. The system of claim 15, further comprising instructions that, when executed by the at least one processor, cause the system to:
generate a project report document comprising information from the first document relevant to the second team; and
provide digital access to the project report document to one or more user accounts associated with the first team and the one or more user accounts associated with the second team.
